(19) United States
(12) Patent Application Publication
(10) Pub. No.: US 2026/0189607 A1
(43) Pub. Date: Jul. 2, 2026

(54) SYSTEM AND METHOD FOR ENRICHING A GENERATIVE MODEL FOR CYBERSECURITY INCIDENT MANAGEMENT

(71) Applicant: Radware Ltd., Tel Aviv (IL)

(72) Inventors: Avi CHESLA, Tel Aviv (IL); Sergei EDELSTEIN, Arad (IL)

(73) Assignee: Radware Ltd., Tel Aviv (IL)

(21) Appl. No.: 19/006,583

(22) Filed: Dec. 31, 2024

(51) Int. Cl. H04L 9/40; H04L 41/16

(52) U.S. Cl. CPC H04L 63/20; H04L 41/16

(57) ABSTRACT

A system and method for enriching a generative model for managing a cybersecurity is presented. The method includes generating textual data from reasoning data of a reasoning model, wherein the reasoning model represents a probabilistic causal relationship amongst a plurality of nodes, and wherein the textual data describes an incident case of the reasoning model in relation to at least one cause; embedding the generated textual data at the generative model in order to create a semantic embedding space; and training the generative model with the embeddings of the textual data.

### TECHNICAL FIELD

The present disclosure relates generally to detecting malicious cyberattacks and more specifically, to enriching a generative model for mitigating an impact incident.

### BACKGROUND

A Security Operations Team (SOC) is a group of experts in an organization that is responsible for monitoring, detecting, responding to, and mitigating cybersecurity threats across the organization's infrastructure. They work to ensure the confidentiality, integrity, and availability of data and systems by continuously monitoring networks, servers, endpoints, and other critical assets. Some example roles of the SOC include, without limitation, incident detection and response, vulnerability management, security tool management, and maintaining an organization's overall security posture.

Current techniques employed by the SOC team include automated threat detection, behavioral analytics, and threat hunting, where experts proactively search for indicators of compromise (IOCs) or tactics, techniques, and procedures (TTPs) used by attackers and utilize incident response playbooks for resolutions. However, it has been identified that SOC still faces challenges arising from the increasing volume of alerts and false positives, false negatives, the evolving sophistication of cyberattacks, especially with the rise of ransomware and APTs (Advanced Persistent Threats), and a shortage of skilled security professionals.

To this end, the growing complexity and scale of threats are not effectively monitored and implemented in determining resolution procedures for cybersecurity incidents. Moreover, the determination of resolution procedures by the SOC often involves manual analysis and decision-making to increase the mean time to recovery (MTTR) from a security incident, which can result in undesired breaching of the organization's infrastructure.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for enriching a generative model for managing a cybersecurity incident. The method comprises: generating textual data from reasoning data of a reasoning model, wherein the reasoning model represents a probabilistic causal relationship amongst a plurality of nodes, and wherein the textual data describes an incident case of the reasoning model in relation to at least one cause; embedding the generated textual data at the generative model in order to create a semantic embedding space; and training the generative model with the embeddings of the textual data.

Certain embodiments disclosed herein also include a non-transitory computer readable medium having stored thereon causing a processing circuitry to execute a process, the process comprising: generating textual data from reasoning data of a reasoning model, wherein the reasoning model represents a probabilistic causal relationship amongst a plurality of nodes, and wherein the textual data describes an incident case of the reasoning model in relation to at least one cause; embedding the generated textual data at the generative model in order to create a semantic embedding space; and training the generative model with the embeddings of the textual data.

Certain embodiments disclosed herein also include a system for enriching a generative model for managing a cybersecurity incident. The system comprises: a processing circuitry; and a memory, the memory containing instructions that, when executed by the processing circuitry, configure the system to: generate textual data from reasoning data of a reasoning model, wherein the reasoning model represents a probabilistic causal relationship amongst a plurality of nodes, and wherein the textual data describes an incident case of the reasoning model in relation to at least one cause; embed the generated textual data at the generative model in order to create a semantic embedding space; and train the generative model with the embeddings of the textual data.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flow diagram illustrating a process of enriching and training a generative model according to an embodiment.

FIG. 3 is a flowchart illustrating a method for enriching a generative model for cybersecurity incidents according to an embodiment.

FIG. 4 is a flowchart illustrating a method for an influence text generation according to an embodiment.

FIG. 5 is a flowchart illustrating a method for identifying a missing feature for an incident case according to an embodiment.

FIG. 6 is a flowchart illustrating a method for generating a response to a cybersecurity incident query according to an embodiment.

FIG. 7 is a schematic diagram of an operation system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for enriching a generative model for predicting and managing impact incidents with improved accuracy and efficiency. A reasoning engine including a generative model is employed for natural language query and response regarding the impact incident. The generative model is trained using data from the reasoning model including, but not limited to, case data, influence data, nodes, reasoning model structure, and the like, and any combination thereof. In an embodiment, the reasoning model represents relationships between cybersecurity incidents, behaviors, observations, predictions, and the like, and any combination thereof, and is configured to generate insights about the cybersecurity incidents. To this end, the generative model is enriched with information on the cybersecurity incidents from experts, detections, analysis, predictions, and more that are represented in the reasoning model.

The embodiments disclosed herein enable an effective training process based on the rich data of the reasoning model that provides insights and causal relationships. In addition, the generative model may be enriched with data from various sources including, for example, but not limited to, local data, global data, public data, and more on threat intelligence and cybersecurity impact incidents. It should be noted that such an enriched generative model has modified weights, semantic embedding spaces, and the like that are tuned and optimized for accurate representation and prediction about the incidents and their prediction domains as well as an organization's security system and/or SOC. To this end.

The embodiments disclosed herein enable efficient training and enrichment of the generative model through direct embedding of textual data. Such textual data describes the relationships and/or insights detected and represented in the reasoning model. The direct embedding of textual data provides contextual details that are focused on the cybersecurity incidents and, in some implementations, specific to an organization, a Security Operation Team (SOC), or the like. To this end, a reliably trained generative model may be achieved faster, with less training, to reduce computational load and time.

The generative model, as disclosed herein, is configured to be continuously learning and to be enriched as the reasoning engine and their models are being applied. New information may be readily incorporated by feeding textual data to be embedded at the generative model. In some implementations, such continuous training may occur automatically, without manual intervention, to improve the efficiency and effectiveness of the generative model training.

In current states of cybersecurity, the SOC is largely responsible for monitoring, detecting, mitigation, and the like against cybersecurity threats across the organization's security system and infrastructure. Although some portions of the SOC responsibilities may be automated, for example, by applying one or more algorithms, full automation that satisfies both the SOC and mitigation effectiveness is not plausible. However, the embodiments disclosed herein enrich the generative model using textual data that are understood by the computing components and SOC personnel. Such characteristics are additionally advantageous to increase processing speed, efficiency, and conservation of computing resources.

Currently employed SOC is often dependent on a group of personnel with expert knowledge of cybersecurity behaviors. To this end, the analyses and responses to queries may be largely subjective and would vary depending on the personnel making such decisions. Moreover, any process from the incident detection to mitigation steps is limited to the knowledge and portions of the cybersecurity-relevant data available to the personnel or members of the SOC, thereby resulting in a long resolution time. The embodiments disclosed herein enable objective decision, based on scores, to generate a comprehensive response to the query related to incidents and/or the organization's security system. As noted above, the quantitatively and logically arranged reasoning model supports the objective and accurate generation of the response that is tailored to the SOC system and the problem domain. Such tailored responses may be challenging to generate in a generally trained generative model. It should be noted that such objective decisions based on an AI-based reasoning engine improve resolution time, for example, from days and hours to minutes or zero, to conserve computing resources. It should be further noted that such strong logical reasoning in the generative model reduces errors such as hallucinations.

In some implementations, a retrieval-augmented generation (RAG) process may be employed to further improve the accuracy of the generated responses. The enriched generative model, as disclosed herein, allows rapid search and discovery of semantically similar or relevant data to the query. To this end, further improvement in the accuracy of the response and efficiency in the generation thereof is obtained.

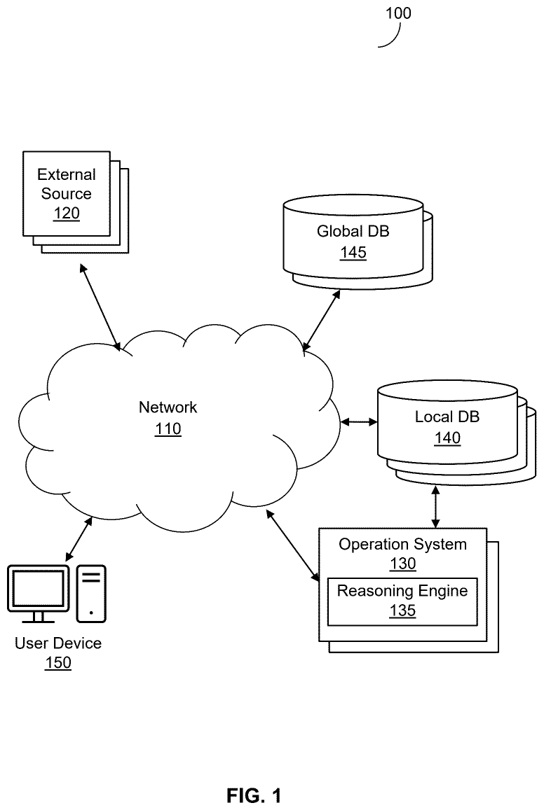

FIG. 1 is a schematic diagram 100 utilized to describe the various disclosed embodiments. In the example schematic diagram 100, an external source 120, an operation system 130, a local database 140, a global database 145, and a user device 150 communicate via a network 110. The network may be, but is not limited to, a wireless, cellular or wired network, a local area network (LAN), a wide area network (WAN), a metro area network (MAN), the Internet, the worldwide web (WWW), similar networks, and any combination thereof.

The external source 120 may be, but not limited to, a service, a platform, a database, or the like, that stores publicly accessible up-to-date threat enrichment data. The external source 120 is managed by an external provider or community to provide information about, without limitation, known threats, malicious sources, bad-actors groups, vulnerabilities, attack vectors, attack tools, and the like. The data at the external sources 120 may be accessed and retrieved from the operation system 130 in order to generate augmented responses to queries. As an example, the external source 120 may be a common vulnerabilities and exposure (CVE) database that is publicly accessible, Adversarial Tactics, Techniques, and Common Knowledge (MITRE ATT&CK) which is a globally accessible knowledge base of adversary tactics and techniques based on real-world observations, or the like. Other examples of external sources 120 include, without limitation, regulatory agencies, community platforms, information-sharing and analysis centers (ISACs), malware analysis services, and the like. It should be noted that a single external source 120 is shown for illustrative purposes and multiple external databases may be communicated without limitation.

The operation system 130 is a component, a server, a system, or the like configured to predict and manage impacts of a cybersecurity incident. A cybersecurity incident is an event or occurrence of compromise or impact on a service and may be related to any cyber-attack that has not been detected or mitigated effectively. Depending on the incident, and the existing cyber security systems, a suitable and effective response may vary and thus, accurate identification of the incident type, root cause, and the like is desired. The operation system 130 is configured to receive detection of incidents with associated data for managing which includes, for example, but is not limited to, analyzing, identifying, determining, triggering mitigation actions or responses, and the like.

The operations system 130 is configured with a reasoning engine 135 that applies at least one algorithm such as a machine learning algorithm to support managing and mitigation of cybersecurity incidents with improved accuracy and efficiency. The reasoning engine 135 includes multiple logical components that are configured to determine the root-cause of a detected cybersecurity incident and determine a suitable protocol or playbook. It generates responses aimed at resolving failures in detecting or mitigating such incidents effectively, based on the identified root-cause and related factors, for a protected entity.

The reasoning engine 135 includes at least one machine learning model that considers conditional and causal relationships between evidence features. Some examples of the at least one machine learning model are, without limitation, a Bayesian belief network (BBN), a language model (LM), a large language model (LLM), or the like that is trained to represent causal relationships between various data (e.g., input data, enrichment data, system configuration data, and the like).

According to the disclosed embodiments, the reasoning engine 135 includes a reasoning model that represents the causal relationships as, for example, a graphical representation. In an embodiment, the reasoning model may be structured as a BBN-based network expanded by an influence diagram that provides specific evidence features and probability dependencies to aid determination. In a further embodiment, such a reasoning model may represent the cause-and-effect relationships as nodes and edges for a specific SOC domain. The causal relationship is employed to generate insights in determining the root-cause and the playbook. The generated insights may include, for example, but are not limited to, a type of incident, at least one key feature, a root-cause, and the like, and any combination thereof that provides additional information of the detected service impact incident. The root-cause points to a reason for failing to detect or mitigate the service impact, thereby causing the impact incident to occur.

In an embodiment, the reasoning model may be generated and/or updated from SOC brief reports. The SOC brief report describes, in the natural human language, the SOC's analysis and report on each incident case including information such as, but not limited to, description and name of impact event, observations, root-case, mitigation action, and the like, and any combination thereof. At least one natural language processing (NLP) algorithm such as, but not limited to, Bidirectional Encoder Representations from Transformers (BERT), Generative Pretrained Transformer (GPT), Recurrent Neural Network (RNN), and the like, may be applied to extract relations between data entities (e.g., evidence, root-cause, resolution playbook, etc.) to be utilized in the influence diagram and/or the causal network of the reasoning model. The SOC brief reports may be retrieved from, for example, but not limited to, the local DB 140, global DB 245, external source 120, and the user device 150 manually, automatically, or both.

Retrieval of SOC brief reports of a specific security system and/or SOC organization allows customized and accurate representation of the SOC domain for the specific system. Moreover, the influence diagram and/or causal network of the reasoning model are rapidly and efficiently generated from textual reports themselves by simplifying the relation extraction based on the problem domain of, for example, but not limited to, an SOC, a protected entity, a security system, and the like. It should be noted that other relational data (e.g., apart from incident cause, evidence, resolution, etc.) may be extracted from the SOC briefs for reasoning with respect to other problem domains.

It should be noted that the reasoning engine 135 described herein enables explainability in the management of cybersecurity incidents, for example, determining the suitable playbook. It should be further noted that the conditional relationships of the reasoning engine reduce the resolution time. Specifically, the disclosed embodiments reduce the time it requires to identify the root cause, missing and/or key influence features, and to select an effective playbook for resolution of the incident. A non-limiting example of a reasoning model is described in detail in U.S. patent application Ser. No. 18/956,707 to Chesla et al. assigned to the common assignee, the contents of which are hereby incorporated by reference.

In an embodiment, the reasoning model may be employed to enrich a generative model for responding to questions related to managing the cybersecurity incidents and the security system of the protected entity. In an embodiment, the generative model of the operation system 130 is configured to generate responses to a wide range of queries relating to, for example, but not limited to, the cybersecurity incident, cybersecurity system, preventions, predictions, mitigation, and the like, and any combination thereof. The potential security incident (hereinafter simply referred to as an incident) is a potential security impact on the service, application, or the like, caused by unaddressed threat, vulnerability, malicious activity, or the like, to be investigated and handled. Some example attacks may include, but are not limited to, Denial of Service (DoS) attack techniques, Distributed Denial of Service (DDoS) attack techniques, and the like, and more.

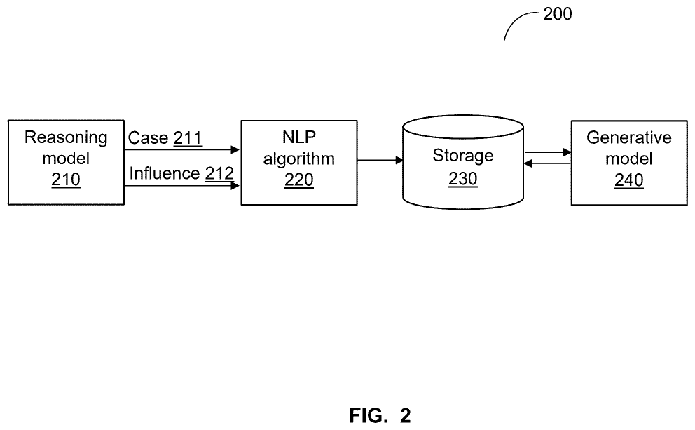

In an embodiment, the generative model is enriched and trained from textual data generated based on the reasoning model to learn the patterns of the cybersecurity incidents and the security system. The textual data are stored at at least one of the local DB 140, the global DB 145, the external sources 120, the user device 150, and the like, and any combination thereof. The enrichment using textual data trains the generative model to the specific SOC and/or security system at the current time and may be continuously enriched for up-to-date accurate responses to queries. The details for enriching the generative model are described in further detail below in FIG. 2. In an embodiment, the trained generative model is configured to receive input query from, for example, the user device 150 and further configured to output an accurate response to the query that may be caused to be displayed at the user device 150. It should be noted that the generative model receives input queries and generates output responses in the natural language for semantic analysis and simplified communications with the user (e.g., an SOC personnel, an analyst, etc.).

The databases 140 and 145 such as, but not limited to, data repositories or databases store security-related data from various sources including, but not limited to, detection tools (not shown), operation system 130, protected entity components and/or servers, and the like. In some implementations, the database 140 may be a security data lake that consolidates data from sources such as, but not limited to, security information and event management (SIEM) systems, network logs, firewall logs, endpoints data, user activity, application logs, vulnerability management tools, threat intelligence feeds, and the like. In an embodiment, the local database 140 stores incident and/or attack related data collected with respect to the protected entity. In an embodiment, the global database 145 stores incident and/or attack related data collected from other protected entities and/or SOC organizations. In some implementations, the global database 145 may be a local storage.

The user device 150 may be, but not limited to, a personal computer, a laptop, a tablet computer, a smartphone, a wearable computing device, or any other device capable of receiving and displaying notifications as well as receiving inputs. The notification may be presented via a graphical user interface (GPU) at the user device 150 as, for example, interactive pages, an alert, a report, and the like, and any combination thereof. The user device 150 may be accessed, for example, by a Security Operation Center (SOC) personnel, for visibility into the cybersecurity incidents, strategies, and executions of the operation system 130.

In addition, the SOC personnel may provide queries (or questions), for example, textual input, voice, images, videos, and the like, and any combination thereof related to the cybersecurity incidents or the security system via one or more input/output (I/O) devices. Such queries may be input in the natural human language and may be related to, for example, but not limited to, system capabilities, resolution plans, insights on detected incidents, optimization methods, preventative measures, and the like, and the like. In such a scenario, the notification includes a response to the query based on the knowledge, insights, protocols, progress, results, and the like available by employing the reasoning engine 135 of the operation system 130.

It should be noted that the elements and their arrangement shown in FIG. 1 are shown for the sake of illustration and simplicity. Other arrangements and/or a number of elements should be considered without departing from the scope of the disclosed embodiments. For example, multiple operation system 130 may be available, for example, for a single entity, multiple entities, or both. In another example, the operation system 130, the local database 140, and the global database 145 may be part of one or more data centers, server frames, or cloud computing platforms. The cloud computing platform may be a private cloud, a public cloud, a hybrid cloud, or any combination thereof. Examples of public cloud computing environments include Amazon® Web Services (AWS), Microsoft® Azure, or Google® Cloud Platform (GCP), which offer shared infrastructure managed by the cloud provider, providing scalability, flexibility, and reduced infrastructure management.

FIG. 2 an example flow diagram 200 illustrating a process of enriching and training a generative model 240 according to an embodiment. The process is performed at the operation system 130, FIG. 1 to train the generative model 240 which is employed to generate responses to queries received from, for example, but not limited to the user device 150, FIG. 1.

According to the disclosed embodiments, the process of enriching and training 200 may be performed intermittently, continuously, on-demand, regularly, or any combination thereof based on expert and system knowledge of the reasoning model 210. As an example, the process 200 is performed when the reasoning model 210, which indicates the causal relationships between different features, and in some implementations a plurality of playbooks, is updated with usage (i.e., applying to incident-related input data) or new threat intelligence information. In another example, the enriching process 200 is performed as a cybersecurity incident case is detected against the protected entity and analyzed.

The reasoning model 210 represents causal relationships between a plurality of features associated with the incident as well as insights such as, but not limited to, a root-cause, a type of incident, a key feature, a missing feature, and the like, and any combination thereof. The features, defined as evidence inputs, are related to the incident and provide the probability of the existence or observation of each evidence type with respect to the related incident. In an example embodiment, the features are extracted from behavioral data associated with a service impacted by the incident. In some implementations, the reasoning model 210 is generated by incorporating expert knowledge from SOC briefs. In an embodiment, such incorporation occurs automatically, manually, or both, by employing methods of natural language processing and relation extraction.

In an example embodiment, an expanded causal network employing a BBN and an influence diagram may be provided or incorporated into at least one machine learning model of the reasoning model 210 to represent the cause-and-effect connections of features as nodes and connecting edges. Such structure of the reasoning model 210 may be automatically generated based on various security data such as, but not limited to, SOC incident brief reports, and the like, that may be available via the local database 140 and/or the global database 145. That is, the structure of the reasoning model 210 incorporates expert, system, and current SOC domain knowledge with enhanced insights.

Such knowledge is generated as reasoning data including, for example, but not limited to, a case data 211, an influence data 212, and the like, and any combination thereof. The case data 211 relates to a specific incident case detected and analyzed at the system including details such as, but not limited to case name, evidence inputs, predicted nodes, respective probabilities, insights, and the like. The influencer data 212 describes the relationships between types, nodes, and the input evidence nodes as structured in the reasoning model 210.

The case data 211 and the influence data 212 are processed 220 using at least one natural language processing algorithm to generate the case textual data and the influence textual data. The natural language descriptions of the case data 211 and the influence data 212 are stored at one or more storages 230 such as, but not limited to, a local database (e.g., the local database 140, FIG. 1) and/or a global database (e.g., the global database 145, FIG. 1). It should be noted that the one or more databases may include data collected and generated for a specific SOC, multiple SOCs, or both for added knowledge.

The textual data generated from the case data 211 and the influence data 212 are fed to the generative model 240 for training and enrichment. The textual data may be directly embedded and utilized for rapid and accurate semantic learning and mapping at the generative model 240. In an embodiment, the training of the generative model 240 may be terminated upon determining the model to be sufficiently trained with respect to predicting root-cause, playbooks, and the like and managing the cybersecurity incident at the organization's system. In an example embodiment, termination is determined when new training data sufficiently matches the existing data at the local data in context to the specific SOC environment. In another example embodiment, the training is terminated when a positive feedback rate is above a predefined threshold rate. In some implementations, the training of the generative model 250 may continue as new data becomes available.

As discussed above, in an embodiment, at least a portion of the reasoning model 210 structure is generated and/or updated based on the NLP and relations extraction from the SOC brief reports in the natural language. The SOC brief report that describes the incident case, impact, root-cause, potential attack, mitigation action and effectiveness, and the like, is analyzed to derive key points associated with the cause-and-effect of the incident case. Here, the data entity such as, but not limited to, evidence node, evidence state, root-cause, resolution playbook, and the like, are identified from the text by natural language processing of sections of the textual data. In an embodiment, the relation types of the textual sections are determined and output. The NLP outputs are aggregated and accumulated to create occurrence and reasoning matrixes. In an embodiment, the reasoning matrix represents the probabilities of cause-and-effect relationships (or transitions) between entities which may be represented as nodes in an influence diagram. Moreover, transition probability values between such nodes are calculated and added as conditional probabilities between the nodes in the BBN.

It should be noted that the reasoning model 210 (i.e., BBN including the influence diagram) accurately implements and represents the relationships and probability predictions between different nodes associated with the incident. Moreover, the reasoning model 210 may be tailored to, for example, the SOC, the security system, the protected entity, and the like, to incorporate unique characteristics of, for example, terminology, methods, capabilities, and the like, and more. By applying NLP techniques, the incorporation of SOC brief reports is readily and rapidly performed to reduce computing complexity and time. It should be further noted that accurate representations in the reasoning model 210 further improve the accuracy of the enriched generative model 240. To this end, not only are the processes simplified, but significantly improved in effectiveness and efficiency in order to conserve computational resources at the operation system 130 as well as the protected entity as a whole.

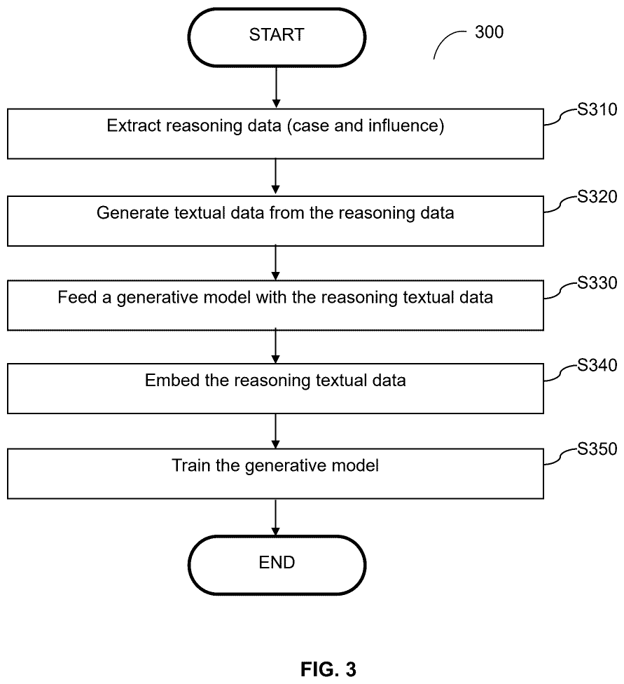

FIG. 3 is an example flowchart 300 illustrating a method for enriching a generative model according to an embodiment. The method described herein is performed at the operation system 130 deployed with a reasoning engine 135, FIG. 1. For simplicity, the method is described with respect to a single generative model in a single operation system 130. However, it should be noted that one or more generative models may be present across multiple operation systems for a protected entity without departing the scope of the disclosed embodiments.

At S310, reasoning data is extracted from the reasoning model. The reasoning model is at least one AI-based model (e.g., the reasoning model 210, FIG. 1) such as, but not limited to, a machine learning model, a classification model, and the like, and any combination thereof. In an example embodiment, the reasoning model 210 is based on a Bayesian belief network (BNN) that is employed with a decision-making influence diagram. The structure and the output generated from the reasoning model provide reasoning data including, for example, but not limited to, a first portion of case data, a second portion of influence data, and the like.

The first portion case data has input and output from each of the impact incidents that are detected, monitored, and processed through the reasoning model to determine mitigation at the operation system (e.g., the operation system 130, FIG. 1). The case data for an incident has, for example, but is not limited to, input data and associated metadata, output data including root-cause insights and a resolution playbook, and the like. Some examples of input data include, without limitation, network configuration, traffic, logs, impact services, and the like, and any combination thereof and the associated examples of metadata include, without limitation, an incident identifier (ID), time stamp, tool or plugin identifier (ID), and the like, and any combination thereof. The output data of the case data for each incident describes the insights such as, but not limited to, type of service impact incident, root-cause, key feature, missing features, and the like, and any combination thereof. Such insights are determined by applying the reasoning model that generates probability scores for nodes of various variables (e.g., evidence feature, insights, etc.) that are relevant to the incident.

The second portion of the reasoning data is the influence data extracted from the structure of the reasoning model to describe the causal relationships between various data (e.g., input data, enrichment data, system configuration data, and the like). As noted above the diagram of the reasoning model includes multiple nodes of data, features, insights, playbooks, and the like, which are connected to one or more other nodes through edges indicating the cause-and-effect relationships. In an embodiment, the influence data describes key dependencies, cause-and-effect relationship, and the like, and more.

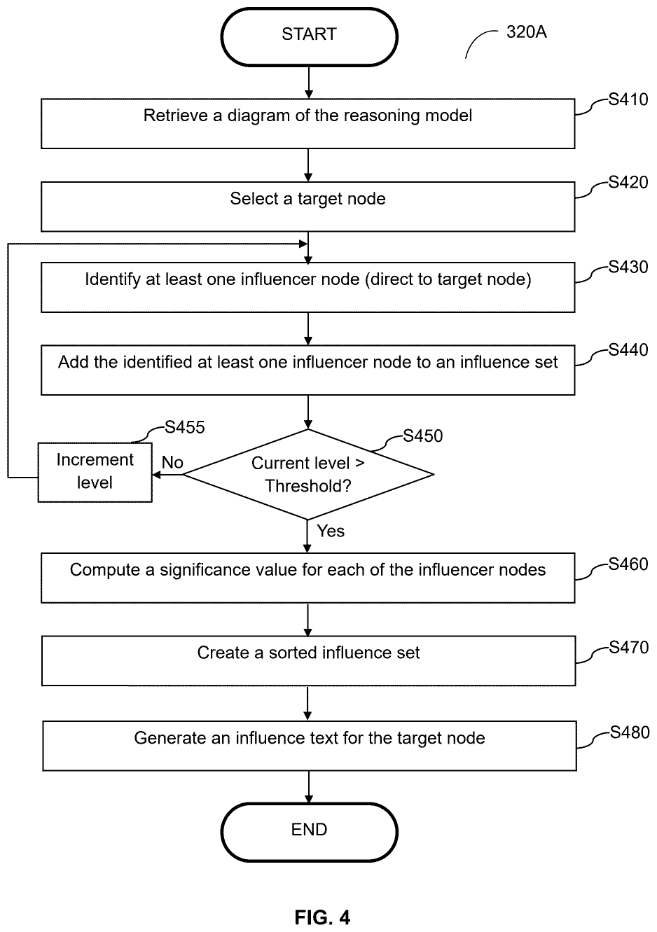

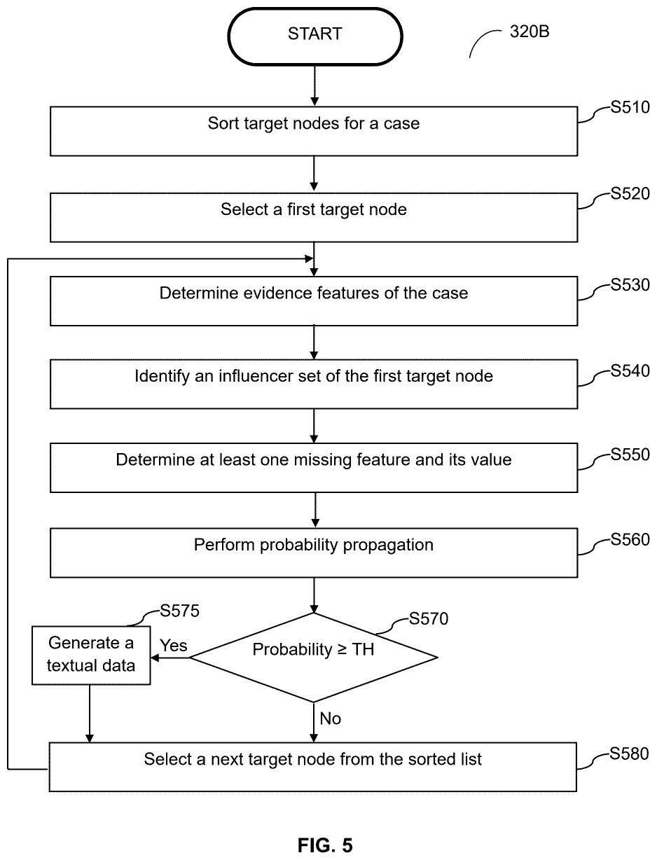

At S320, textual data are generated for the extracted reasoning data. The reasoning data including at least a first portion of case data and the second portion of influence data are processed to generate textual data in the natural language. The case textual data of the first portion of the reasoning textual data presents a reasoning description of a real incident case including, for example, but not limited to, input data, insights, a resolution playbook, and the like. As an example, the case textual data is a series of sentences discussing the impact incident and predictions on why such impact may have occurred, and why the system (e.g., the operation system 130 deployed with a reasoning engine 135, FIG. 1) has made such predictions. The influence textual data is a description of the connections in the reasoning model. As an example, the influence textual data has multiple sentences narrating the dependencies, main dependencies, key features or influencers, and the like, and any combination thereof. The details of generating the case textual data and the influence textual data are described in further detail below in FIGS. 4 and 5. In an embodiment, the reasoning textual data may be stored at a local database and/or a global database (e.g., the local database 140 and the global database 145, FIG. 1)

At S330, the reasoning textual data are fed to a generative model. The generative model is at least one generative model such as, but not limited to, a language model, a large language model, and the like. Some examples of the generative model include, for example, but not limited to, Generative Pretrained Transformer 3 (GPT-3), Generative Pretrained Transformer 4 (GPT-4), Bidirectional Encoder Representations from Transformers (BERT), Text-to-Text Transfer Transformer (T5), Pathways Language Model (PaLM), Conditional Transformer Language model (CTRL), and the like, and more. It should be noted that the reasoning textual data are rich in relational information about evidence features, cybersecurity impact, past and current mitigation decisions, threat knowledge, and the like. In an embodiment, the reasoning textual data are retrieved from one or more of the local database, global database, and external sources to feed the generative model. The local database 140 stores system-specific and/or private textual data and may be designated to a specific operation system (e.g., the operation system 130, FIG. 1). The global database 145 stores shared data from multiple systems, which may be deployed locally (e.g., directly integrated, same cloud computing platform, etc.) to the operation system 130. The external sources are public data on cybersecurity or threat intelligence, for example, but not limited to, CVE database, open source security tools, regulatory data, academics, MITRE ATT&CK, and the like, and any combination thereof.

At S340, the reasoning textual data is embedded. The reasoning textual data fed in the natural language are tokenized and transformed into vector embeddings using at least one algorithm such as, but not limited to, Word to Vector (Word2Vec), Global Vectors for Word Representation (GloVe), BERT, and the like, and more. In an embodiment, the reasoning textual data is directly embedded at the fed generative model without intermediate processing, thereby reducing complexity and computing load at the computing resources for the generative model. The embeddings map reasoning textual data in an embedding space. The embeddings capture the semantic meaning of the reasoning textual data to map similar and/or related concepts closer together in an embedding vector space. It should be noted that such embeddings and the semantic embedding space allow rapid classification and discovery of relevant information in applying the generative model, thereby reducing computational load and time for accurate response.

At S350, the generative model is trained using the vector embeddings of the reasoning textual data. The generative model is trained to learn the patterns of the embedded reasoning textual data that provide knowledge on the cybersecurity incident and related information such as system configuration, system status, and the like, and any combination thereof. It should be noted that training using the generated vector embeddings provides substantial details on the cause-and-effect of the features and incidents that are otherwise not available in a regularly trained generative model.

The training of the generative model may continue until determined that sufficient training has been performed. In an example embodiment, sufficient training is determined when all available reasoning textual data are fed to train the generative model. In another example embodiment, the training stops with convergence of a loss function. In yet another example embodiment, the sufficient training is determined with a predetermined number of training iterations using the fed data. Some other example criteria for termination training of the generative model include when a learning rate matches that of the local data, when a high rate of positive feedback is reached above a predefined threshold value, and the like. In an embodiment, training the generative model is an enriched generative model with the contextual and relational understandings related to the cybersecurity impact incident. Moreover, the generative model includes system-specific information to provide, for example, system-specific responses to questions related to the incident and the cybersecurity system for the entity as a whole. To this end, the trained generative model allows faster and more accurate responses to the query from, for example, an SOC personnel of the protected entity.

According to the disclosed embodiments, the generative model is configured to continuously learn by incorporating new data into its knowledge base through, for example, periodic updates in the reasoning model. As an example, the new data may be from an incident that was detected and analyzed using the reasoning model. In another example, the new data may be changes in the reasoning model structure from expert knowledge, shared data, and the like, and any combination thereof. In an embodiment, learning at the generative model may continue through reinforcement learning based on feedback received on, for example, a suggestion, an action, or the like that is caused to be displayed, for example, as a notification at a user device (e.g., the user device 150, FIG. 1).

FIG. 4 is an example flowchart 320A illustrating a method for an influence text generation according to an embodiment. The method described herein is performed in an operation system 130, FIG. 1. The process is described with respect to a single target node in the reasoning model diagram for simplicity and does not limit the scope of the disclosed embodiments. The method may be performed for the plurality of nodes in the diagram simultaneously, successively, intermittently, on-demand, or any combination thereof without departing the scope of the disclosed embodiments.

At S410, a diagram (or structure) of the reasoning model is retrieved. The diagram of the reasoning model illustrates the causal relationship between various nodes such as, but not limited to, network behavior, attack behavior, type, root-cause, playbook, and the like, and any combination thereof that are connected by edges describing respective transitional probabilities. In an embodiment, the diagram is a Bayesian belief network (BNN)-based structure that is combined with an influence diagram to support reasoning and determination against detected incidents. Other relationship diagrams generated for the reasoning model may be retrieved. In an example embodiment, the diagram is generated for an SOC or a protected entity. The diagram of the reasoning model may be updated and changed as new data relevant to the SOC, the cybersecurity incident, and the like are received.

At S420, a target node is selected. The target node is defined as a node on the diagram defining an insight such as, but not limited to, a root-cause node, a resolution playbook node, or the like. In an embodiment, a plurality of selection rules may be applied to select the target node where the plurality of selection rules includes, for example, but not limited to, weights, ranks, scores, and the like, and any combination thereof. That is, the plurality of selection rules may be applied based on, for example, but not limited to, type of node, probability, and the like, and any combination thereof. As an example, a target node with high probability may be selected with priority. In another example, the target node is selected from the playbook type or root-cause type. In such a scenario, one target node may be arbitrarily selected based on the type without priority since all relevant nodes may be analyzed.

At S430, at least one influencer node is identified. The at least one influencer node is a node connected to the target node through the edges. In an embodiment, the at least one influencer node at a first level (i.e., Level 1) is initially identified. The first level indicates one edge distance between the influencer node and the target node. That is, the first level at least one influencer node is a node that is directly connected and one edge apart from the selected node.

At S440, the identified at least one influencer node is added to an influence set. The influence set includes at least one influencer node connected to the target node. Thus, the influence set may be specific to the selected target node.

At S450, it is checked whether a current level is greater than a predefined threshold level value. If so, the operation continues with S460; otherwise, the operation continues with S455. The predefined threshold level is utilized in order to prevent adding nodes that have a low impact on the target node. That is, influencer nodes that are distant above the predefined threshold level value are considered less relevant in the cause-and-effect relationship to the target node.

At S455, the current level is incremented by one and returns to S430 to identify at least one influencer node at the incremented current level (i.e., one edge further away from the selected target node and directly connected to the identified influencer node at the current level). As an example, at a first check at S450, the current level is Level 1, and the incremented level is Level 2 which indicates 2 edges away from the selected targeted node and direct connection to the Level 1 influencer nodes identified in S430. Upon returning to S430, at least one influencer node is at the incremented current level, thus a second level (i.e., Level 2) is identified. The at least one influencer node is directly connected to the first level and two edges away from the target node. Such process is performed repeatedly based on the criteria of S450 to determine influencer nodes directly connected to the previous level before incrementing.

At S460, a significance value for each of the influencer nodes in the influence set is computed. The significance is a quantitative indicator of the influence or impact of the at least one influencer node towards the target node. In an embodiment, the significance is measured by counting the number of routes originating from each influencer node towards the target node. As an example, a Level 1 influencer node that is connected to the target node with one edge and two edges. As an example, a Level 1 influencer node that is connected to the target node directedly by one edge and connected to another Level influencer node (thus, two edges from the target node) is computed to have a significance value of two.

At S470, a sorted influence set is created. The influencer nodes in the influence set are sorted based on the Level value (i.e., distance away from the target node) and the respective significance value. In an embodiment, the Level value is given priority to sort the influencer nodes from the lowest level to the highest level. In an example embodiment, the lowest level is 1 which is a direct connection and a shortest distance from the target node. Amongst influencer nodes with the same Level value, the influencer nodes are sorted from the greatest significance value to the smallest significance value. In an embodiment, the influence set and/or the sorted influence set may be generated using, for example, but not limited to, Markov Blanket concept, a traversal algorithm, graph libraries, Bayesian network libraries, and the like.

At S480, the influence text is generated based on the sorted influence set. The sorted influence set that describes the cause-and-effect relations with respect to the target node is transformed into natural language textual data. In an embodiment, the influence text may be generated based on a predetermined case template. In such a scenario, type, values, target names, prediction probabilities, missing evidence, and the like, and any combination thereof derived from the reasoning model structure are considered to generate a natural language influence text. In an embodiment, the generated influence text is stored at a local database and/or a global database (e.g., the local database 140 and the global database 145, FIG. 1).

FIG. 5 is an example flowchart 320B illustrating a method for identifying a missing feature for an incident case according to an embodiment. The method described herein may be performed in the operation system 130, FIG. 1. The identified missing features may be added to the case to be represented as part of a case textual data.

The case textual data is a natural language description of a specific impact incident (herein referred to as a case) detected and analyzed at the operation system 130. In an embodiment, the case textual data includes, for example, but not limited to, a case name defined by a name and/or an identifier (ID), evidence feature input values, predicted nodes and respective prediction probabilities, a summarization of at least one predicted insight (e.g., root-cause, resolution playbook, etc.), and the like, and any combination thereof. The prediction nodes may be, for example, an evidence node, a root-cause node, a resolution playbook node, or the like and identified during inference of the reasoning model for the case. In some implementations, the generated case textual data may be shared with other SOC systems or protected entities via, for example, the global database (e.g., the global database 145, FIG. 1).

In an embodiment, the prediction probabilities for one or more nodes queried during the inference of the case may be below a predetermined threshold value. An example predetermined threshold value is, without limitation, 0.5, 0.7, or the like. The low probabilities suggest that clear insights cannot be determined for the incident case. In such a scenario, missing features that may increase the low probabilities and result in sufficiently notable insights into the case are identified. It should be noted that such missing features are objectively predicted to guide further feature collection. It should be noted that such missing features are objectively predicted to provide additional information on the specific case for improved description and management suggestions for the incident case.

At S510, target nodes for the case are sorted. The target nodes such as, the root-cause node, the resolution playbook node, and the like are the predicted nodes for the case. As noted above, the target nodes and respective predicted probabilities are determined by analyzing the case using the reasoning model. In an embodiment, target nodes are sorted in a descending order of their respective predicted probabilities. It should be noted that the predicted probabilities and the target nodes may differ for each case (i.e., incident) based on the input data and the extracted evidence features.

At S520, a first target node with a highest probability is selected. That is, the first target node is the top-most target node that has the highest predicted probabilities from the sorted list at S510.

At S530, evidence features that are input to the reasoning model are determined. The evidence features (or evidence inputs) are extracted from input data of the detected incident and fed to the reasoning model during inference. The feature is an evidence that is related to the incident and provides the probability of existence or observation of each evidence type, which may be, a hard evidence (e.g., yes or no), a soft evidence (e.g., probability of existence, etc.), or the like. An example of soft evidence (or feature) may be a 30% deviation from a baseline traffic. An example of the features may include rate baseline excessive ratio indicating the relationship between network rate baselines of a first detection system to a second detection system.

At S540, an influencer set of the first target node is retrieved. The influencer set includes nodes that are relevant to and thus connected by edges to the target node in the diagram. In an embodiment, the influencer set for the target node is determined as described in FIG. 4.

At S550, at least one missing feature (i.e., missing evidence input) is determined. The input evidence features (S530) are compared to the influencer set (S540) to identify at least one influencer node of the influencer set that is not part of the input evidence features. In such a scenario, the influencer node that is related to the target node, but not input as the feature of the incident is determined to be a missing feature.

At S560, a probability propagation is performed using the determined at least one missing feature, a set of values of the at least one missing feature, and input evidence features in order to predict and update the predicted probabilities. In an embodiment, the set of values for the at least one missing feature may be generated through simulation. The probability propagation is simulated using each individual value of the set of values to determine the predicted probability of the target node. In an embodiment, the predicted probabilities are logged with respect to the case and stored in a local database (e.g., the local database).

At S570, it is checked whether the predicted probability is equal to or greater than a predefined threshold probability. If so, the operation continues with S575; otherwise, the operation continues with S580. In an example embodiment, the predefined threshold probability is 0.7. The predicted probability equal or greater than the predefined threshold probability validates that the at least one missing feature, for example, at a certain value may be the key feature for a distinguishable predicted probability. That is, such missing feature is identified as the key feature that when received would strongly affect the predicted probabilities for a definite decision.

At S575, a case textual data including the at least one missing feature and insights from the probability propagation are generated. In an embodiment, the insights such as, but not limited to, nodes, predicted probabilities, and the like, from the probability propagation, are logged. In some implementations, a notification to suggest the key missing features for the case may be generated. The operation continues with S580.

At S580, a next target node is selected from the sorted list (S510); and the operation returns to S530 to identify the at least one missing feature for the case. It should be noted that other target nodes of the case are processed to identify missing features related to the other target nodes.

In an embodiment, the process may terminate when all target nodes on the sorted list (S510) are processed. In another embodiment, the process may terminate upon processing and logging a predefined number of target nodes. In yet another embodiment, upon determining that a predefined number of targets analyzed have predicted probabilities above the predefined threshold probability, for example, 0.5, the process may terminate for the respective case.

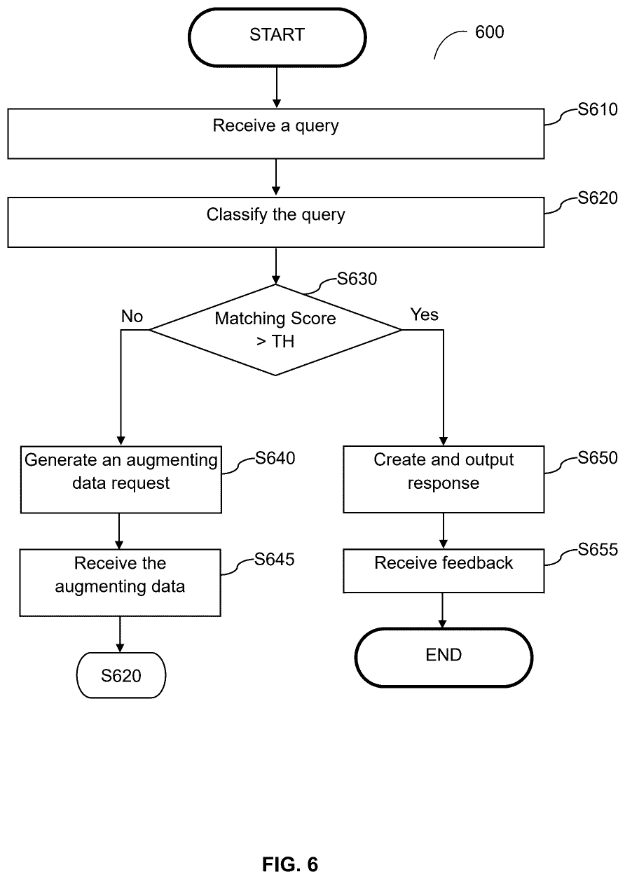

FIG. 6 is an example flowchart 600 illustrating a method for generating a response to a cybersecurity incident query according to an embodiment. The method described herein is performed in the operation system 130, FIG. 1 by employing a trained generative model. The generative model is trained and enriched with cybersecurity incident data as described above in FIG. 3. The generative model may be, for example, but not limited to, GPT-3, GPT-4, BERT, Text-to-Text Transfer Transformer (T5), Pathways Language Model (PaLM), Conditional Transformer Language model (CTRL), and the like, and more.

In an embodiment, the generative model is configured to receive queries and generate responses, both in the natural language. In a further embodiment, the enriched generative model is configured to provide accurate responses to queries associated with various stages of cybersecurity incidents for prevention, investigation, mitigation, post-incident prevention and optimization, and the like, and any combination thereof.

At S610, a query is received. The query (or a question) related to a cybersecurity incident may be received from, for example, a user device (e.g., the user device 150, FIG. 1), a local database with a predetermined list of queries, or the like in the form of natural language sentences. The user device may be utilized by a person or agent of an SOC that monitors and manages the threats or cybersecurity incidents against the protected entity and/or entities. In an embodiment, the received query is tokenized and transformed into a vector embedding.

At S620, the query is classified based on semantic similarity. The embedding space of the reasoning textual data is searched to classify the query. In an embodiment, at least one algorithm such as a similarity algorithm is applied to classify and represent the closely by a matching score. It should be noted that the embedding space includes data collected and stored at one or more databases (e.g., the local database, the global database, the external source, etc.).

At S630, it is checked whether the matching score is greater than a predefined threshold score. If so, the operation continues with S650; otherwise, the operation continues with S640.

At S640, an augmenting data request is generated. Upon determination that the matching score is equal or smaller than the predefined threshold score, the generative model is configured to generate a request for augmenting data. In an embodiment, the type of augmenting data type is determined by relevance to the query. In a further embodiment, such a request is generated as part of a Retrieval-Augmented Generation (RAG) process.

At S645, the augmenting data relevant to the query is received. In an embodiment, the augmenting data may be provided by a user of the user device. In a further embodiment, the augmenting data is automatically searched and retrieved from the one or more databases including local, global, and public data. It should be noted that the embeddings generated of the stored data and the query allow rapid search and retrieval of relevant augmenting data. Upon receiving the augmenting data, the operation returns to S630 to classify the query and determine a new matching score with the additional augmenting data.

At S650, a response to the query is generated and output. The response is the answer in the natural language to the input query. The generation is triggered with a sufficiently high matching score indicating contextual similarity to available data for accurate answer. In an example embodiment, the response may suggest a missing evidence feature according to the semantic proximity of the query to such influence data as described in FIG. 4 or FIG. 5. In an embodiment, the response may be caused to be displayed at the user device (e.g., the user device 150, FIG. 1). In a further embodiment, the response may be stored or logged at a database. It should be noted that the response using the enriched generative model provides a comprehensive response in consideration of the organization's security system as a whole, as well as proving a response with improved accuracy.

At S655, a feedback on the generated and output response is received. The feedback may be received from a user of the user device. In an example, the user is a personnel or analyst of the SOC. In an embodiment, the feedback may be input via one or more I/O devices of the user system. Such feedback may be input as, for example, but not limited to, a Boolean (e.g., yes or no, positive or negative, like or dislike, etc.), a score, a textual feedback, and the like, and any combination thereof. In some implementations, the feedback may be employed for further training and enriching of the generative model.

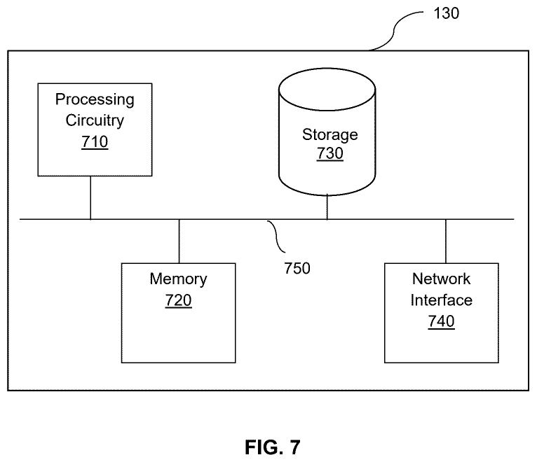

FIG. 7 is an example schematic diagram of an operation system 130 according to an embodiment. The operation system 130 includes a processing circuitry 710 coupled to a memory 720, a storage 730, and a network interface 740. In an embodiment, the components of the operation system 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), Application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 740 allows the operation system 130 to communicate with, for example, the external source 120, the local database 140, the global database 145, the user device 150, and the like.

It should be understood that the embodiments described herein are not limited to the specific architecture illustrated in FIG. 7, and other architectures may be equally used without departing from the scope of the disclosed embodiments.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for enriching a generative model for managing a cybersecurity incident, comprising:
generating textual data from reasoning data of a reasoning model, wherein the reasoning model represents a probabilistic causal relationship amongst a plurality of nodes, and wherein the textual data describes an incident case of the reasoning model in relation to at least one cause;
embedding the generated textual data at the generative model in order to create a semantic embedding space; and
training the generative model with the embeddings of the textual data.

2. The method of claim 1, further comprising:
extracting the reasoning data indicating the probabilistic causal relationship between nodes in the reasoning model with respect to the at least one cause.

3. The method of claim 1, wherein the incident case has at least one of: a case name, an input evidence feature, a predicted node, a respective probability, a summarization of the predicted node, a root-cause, and a resolution playbook.

4. The method of claim 1, further comprising:
retrieving the reasoning data from at least one of: a local database, a global database, and an external resource.

5. The method of claim 1, further comprising:
generating the reasoning model based on a plurality of security operation center (SOC) brief reports, wherein the SOC brief reports describe the incident case in a natural language.

6. The method of claim 5, wherein the generating the reasoning model further comprises:
identifying features and a transition between two features by natural language processing;
aggregating the identified features; and
generating a reasoning matrix from the aggregation to represent the causal relationships and respective probabilities.

7. The method of claim 1, further comprising:
detecting, based on a low prediction probability, that the cause cannot be determined for the incident case;
identifying a missing feature for the incident case, wherein the missing feature is predicted to increase the low prediction probability; and
adding the identified missing feature to the reasoning data.

8. The method of claim 2, wherein extracting the reasoning data further comprises:
selecting a target node from the plurality of nodes of the reasoning model;
identifying at least one first influencer node connected to the target node;
adding the at least one first influencer node to an influence set; and
repeating the identifying and adding in order to identify a consecutively connected subsequent level influencer node, wherein the subsequent level influencer node is directly connected to a previous level influencer node.

9. The method of claim 1, further comprising:
applying the trained generative model to output a response to a query related to the cybersecurity incident.

10. A non-transitory computer readable medium having stored thereon instructions for causing a processing circuitry to execute a process, the process comprising:
generating textual data from reasoning data of a reasoning model, wherein the reasoning model represents a probabilistic causal relationship amongst a plurality of nodes, and wherein the textual data describes an incident case of the reasoning model in relation to at least one cause;
embedding the generated textual data at a generative model in order to create a semantic embedding space; and
training the generative model with the embeddings of the textual data.

11. A system for enriching a generative model for managing a cybersecurity incident, comprising:
a processing circuitry; and
a memory, the memory containing instructions that, when executed by the processing circuitry, configure the system to:
generate textual data from reasoning data of a reasoning model, wherein the reasoning model represents a probabilistic causal relationship amongst a plurality of nodes, and wherein the textual data describes an incident case of the reasoning model in relation to at least one cause;
embed the generated textual data at the generative model in order to create a semantic embedding space; and
train the generative model with the embeddings of the textual data.

12. The system of claim 11, wherein the system is further configured to:
extract the reasoning data indicating the probabilistic causal relationship between nodes in the reasoning model with respect to the at least one cause.

13. The system of claim 11, wherein the incident case has at least one of: a case name, an input evidence feature, a predicted node, a respective probability, a summarization of the predicted node, a root-cause, and a resolution playbook.

14. The system of claim 11, wherein the system is further configured to:
retrieve the reasoning data from at least one of: a local database, a global database, and an external resource.

15. The system of claim 11, wherein the system is further configured to:
generate the reasoning model based on a plurality of security operation center (SOC) brief reports, wherein the SOC brief reports describe the incident case in a natural language.

16. The system of claim 15, wherein the system is further configured to:
identify features and a transition between two features by natural language processing;
aggregate the identified features; and
generate a reasoning matrix from the aggregation to represent the causal relationships and respective probabilities.

17. The system of claim 11, wherein the system is further configured to:
detect, based on a low prediction probability, that the cause cannot be determined for the incident case;
identify a missing feature for the incident case, wherein the missing feature is predicted to increase the low prediction probability; and
add the identified missing feature to the reasoning data.

18. The system of claim 12, wherein the system is further configured to:
select a target node from the plurality of nodes of the reasoning model;
identify at least one first influencer node connected to the target node;
add the at least one first influencer node to an influence set; and
repeat the identifying and adding in order to identify a consecutively connected subsequent level influencer node, wherein the subsequent level influencer node is directly connected to a previous level influencer node.

19. The system of claim 11, wherein the system is further configured to:
apply the trained generative model to output a response to a query related to the cybersecurity incident.
